(19) United States
(12) Patent Application Publication
(10) Pub. No.: US 2021/0094068 A1
(43) Pub. Date: Apr. 1, 2021

(54) System and Method of Matching a Paint Color to an Automotive Surface

(71) Applicant: Michael G Leyba, Santa Fe, MN (US)

(72) Inventor: Michael G Leyba, Santa Fe, MN (US)

(21) Appl. No.: 16/789,294

(22) Filed: Feb. 12, 2020

Related U.S. Application Data
(60) Provisional application No. 62/907,169, filed on Sep. 27, 2019.

(51) Int. Cl. B05D 7/14; B05D 7/00

(52) U.S. Cl. CPC B05D 7/14; B05D 7/54

(57) ABSTRACT

A system and method of matching a paint color to an automotive surface generates a final color composition that accurately matches a current color for a repaintable surface of an automobile. The system for the present invention includes a primary transparent card and a plurality of spray paints, wherein each spray paint is associated to a paint color. The paint color of each spray paint is compared to the current color and applied as a plurality of primary shades onto the primary transparent card. The repaintable surface is overlaid with the primary transparent card, and a matching primary shade is identified. The matching primary shade is appended into the final color composition. The repaintable surface is repainted with the final color composition. The system further includes at least one secondary transparent card that allows for the identification of at least one color-modifying spray paint from the plurality of spray paints.

The current application claims priority to U.S. provisional application Ser. No. 62/907,169 filed on Sep. 27, 2019.

### FIELD OF THE INVENTION

The present invention generally relates to the use of paint colors. More specifically, the present invention matches a paint color to an automotive surface.

### BACKGROUND OF THE INVENTION

Repainting or touching up a paint job for an automobile can take a lot of time and resources that may not create an exact replica of the original color of the automobile. Layering spray paint colors in an attempt to blend the damaged areas of the automobile creates an uneven surface across the automobile. This results in an unprofessional and unfinished look. Further repairing the damage from this mismatch takes even more time and puts the exterior of the automobile at further risk.

It is therefore an objective of the present invention to mix and match spray paint colors without having to test multiple trials directly on the damaged areas of the automobile. The present invention provides both the correct combination and exact proportions of spray paint colors that mirror the existing paint color of the automobile. The present invention allows a user to preview combinations of spray paint colors in an attempt to recreate the existing paint color without wasting spray paint for each previewed combination. The present invention allows for multiple trials with transparent cards and a final trial with an opaque metal card which provides a comparable surface with that of the damaged area of the automobile.

### BRIEF DESCRIPTION OF THE DRAWINGS

FIG. 1 is a schematic view of the system used to implement the method of the present invention.

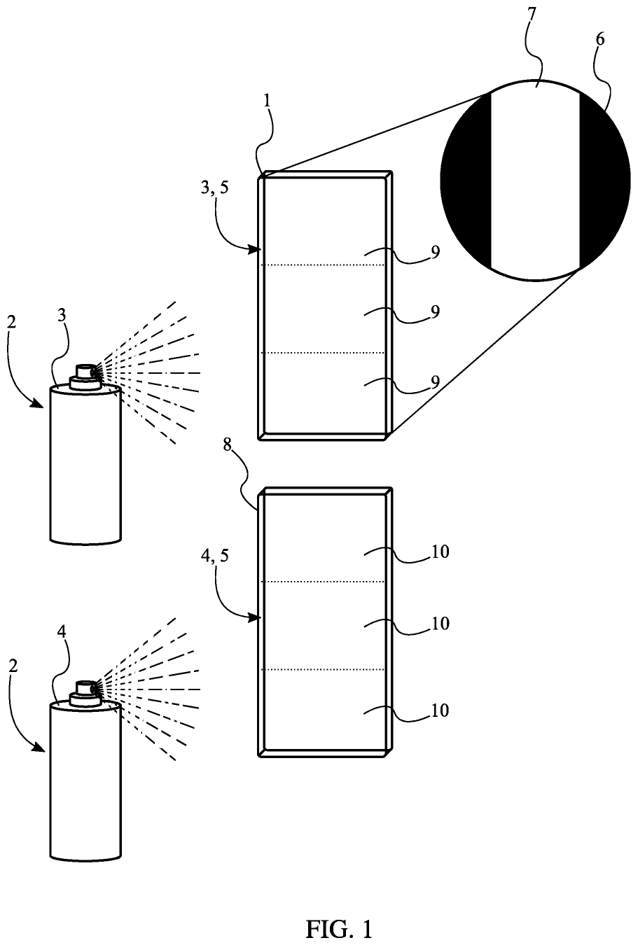

FIG. 2 is a flowchart illustrating the overall process for the present invention.

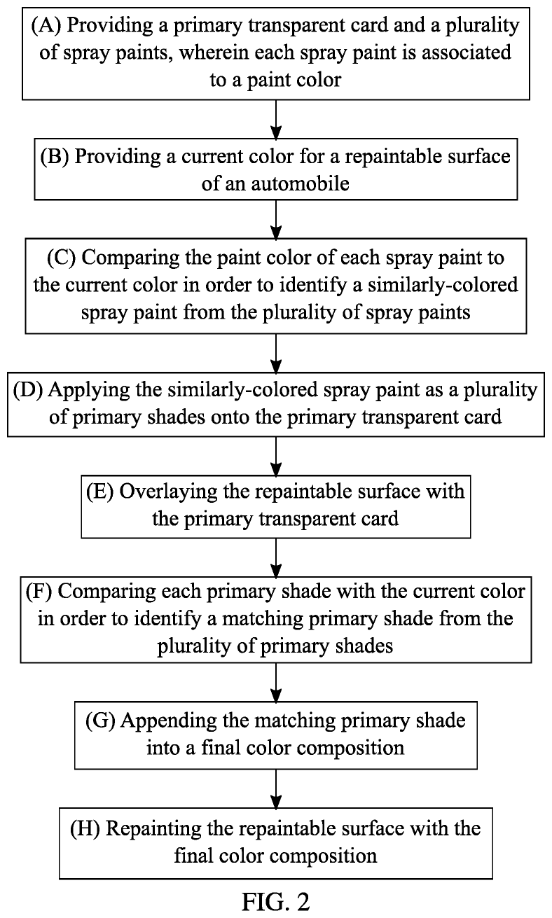

FIG. 3 is a flowchart illustrating the subprocess for applying a coat of toner for the present invention.

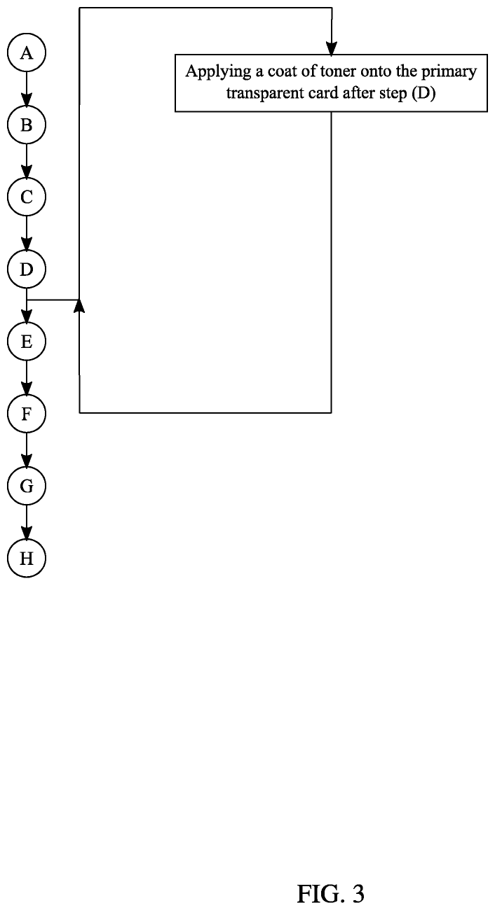

FIG. 4 is a flowchart illustrating the subprocess for applying a similarly-colored spray paint gradually across a primary transparent card for the present invention.

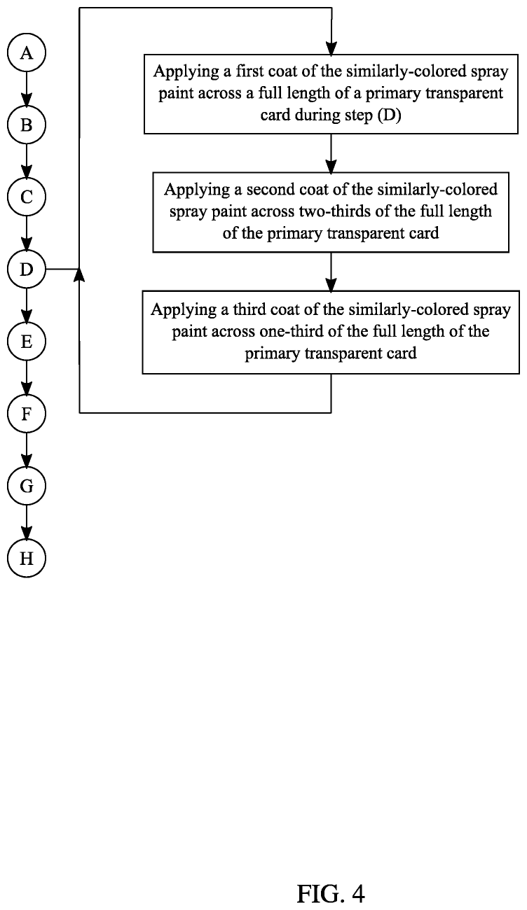

FIG. 5 is a flowchart illustrating the subprocess for identifying and appending at least one color-modifying spray paint with at least one secondary transparent card for a final color composition for the present invention.

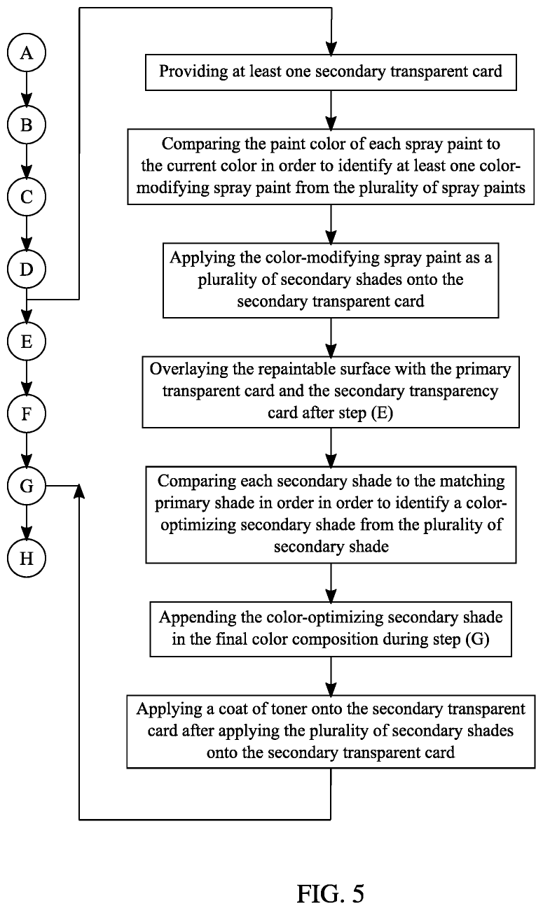

FIG. 6 is a flowchart illustrating the subprocess for verifying the final color composition with an opaque metal card with the final color composition for the present invention.

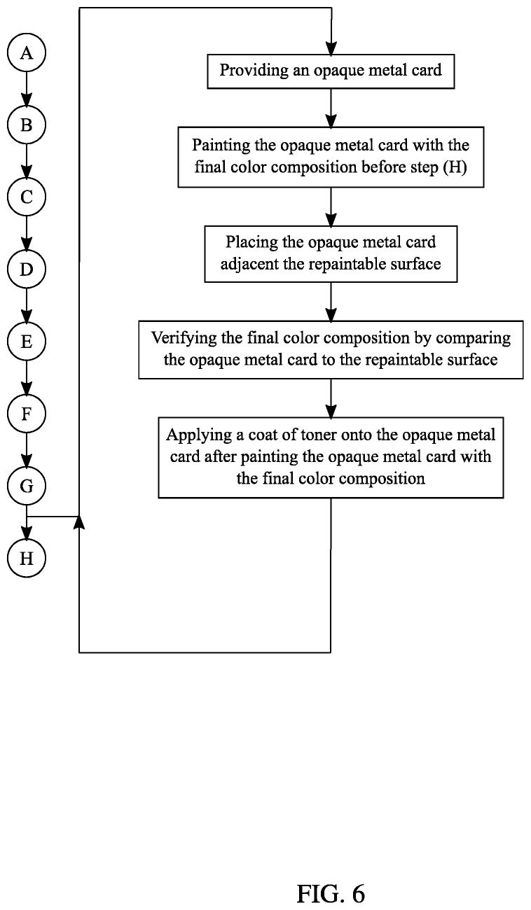

### DETAIL DESCRIPTIONS OF THE INVENTION

All illustrations of the drawings are for the purpose of describing selected versions of the present invention and are not intended to limit the scope of the present invention.

The present invention is a system and method of matching paint color to an automotive surface. The present invention accurately replicates the exact shade of a desired paint color. Moreover, the present invention preserves the integrity of an automotive surface while producing the correct combination of colors in order to reproduce the desired paint color. The present invention reduces the number of layers of spray paint across the automobile surface by allowing various combinations of colors to be tested before application for an even and finished look. Thus, the physical system used to implement the method for the present invention includes a primary transparent card 1 and a plurality of spray paints 2. The primary transparent card 1 displays a selected spray paint of the plurality of spray paints 2. More specifically, each spray paint 2 is associated to a paint color 5 (Step A). The plurality of spray paints 2 provides a variety of colors that may match the desired paint color and coat the repaintable surface 7 of the automobile. The present invention further includes a current color 6 for a repaintable surface 7 of an automobile (Step B). The current color 6 is the desired color that serves as a base for the combination of colors and surrounds the repaintable surface 7. The repaintable surface 7 is typical an area across the automobile surface that has been damaged or an area where the layers of paint have been worn down so that the metal frame of the automobile is exposed.

The overall process followed by the method of the present invention allows the primary transparent cards 1 and the plurality of spray paints 2 to accurately repaint the current color 6 for a repaintable surface 7 into the desired paint color. The overall process begins by comparing the paint color 5 of each spray paint 2 to the current color 6 in order to identify a similarly-colored spray paint 3 from the plurality of spray paints 2 (Step C). The similarly-colored spray paint 3 is the closest visible match with that of the current color 6 for the repaintable surface 7 of the automobile. The similarly-colored spray paint 3 is applied as a plurality of primary shades 9 onto the primary transparent card 1 (Step D) in order to determine how many layers of the similarly-colored spray paint 3 is needed in order to match the current color 6 of the repaintable surface 7 of the automobile. Each primary shade 9 features a similar or the same color and hue as that of the desired paint color. The repaintable surface 7 is overlaid with the primary transparent card 1 (Step E) in order to visually compare the similarly-colored spray paint 3 with the current color 6 of the repaintable surface 7 of the automobile. In order to ensure an accurate match, each primary shade 9 is compared with the current color 6 in order to identify a matching primary shade 9 from the plurality of primary shades 9 (Step F). The matching primary shade 9 is appended into a final color composition (Step G), thereby generating the current color 6 with the matching primary shade 9 of the similarly-colored spray paint 3. The repaintable surface 7 is repainted with the final color composition (Step H), and the repaintable surface 7 of the automobile blends smoothly with the current color 6.

In order for the paint color 5 of the similarly-colored spray paint 3 to be accurately represented, a coat of toner is applied onto the primary transparent card 1 after Step D. The coat of toner provides a polished look. The coat of toner enhances the vibrancy of the paint color 5 and accurately represents the appearance of the paint color 5 while applied to a surface. The primary transparent card 1 more accurately represents the finished appearance of the similarly-colored spray paint 3 as the coat of toner may slightly change the hue or appearance of the similarly-colored spray paint 3 without the coat of toner.

In order to create the final color composition with the correct proportions of the plurality of primary shades 9, a first coat of the similarly-colored spray paint 3 is applied across a full length of a primary transparent card 1 during Step D. The first coat presents how a single layer of the similarly-colored spray paint 3 appears on the repaintable surface 7 of the automobile. A second coat of the similarly-colored spray paint 3 is applied across two-thirds of the full length of the primary transparent card 1. The second coat presents how a double layer of the similarly-colored spray paint 3 appears on the repaintable surface 7 of the automobile. A third coat of the similarly-colored spray paint 3 is applied across the one-third of the full length of primary transparent card 1. The third coat presents how a triple layer of the similarly-colored spray paint 3 appears on the repaintable surface 7 of the automobile. Moreover, each coat serves as an indication for the necessary proportion of the similarly-colored spray paint 3 with the final color composition.

In order to create the exact combination color combination for the final color composition, at least one secondary transparent card 8 is provided. The at least one secondary transparent card 8 upholds a paint color 5 that may or may not be combined with the primary shade 9 across the primary transparent card 1. The secondary transparent card 8 with the paint color 5 of each spray paint may adjust the overall look of the final color composition in order to better match the current color 6 of the repaintable surface 7. The paint color 5 of each spray paint is compared to the current color 6 in order to identify at least one color-modifying spray paint 4 from the plurality of spray paints 2. The color-modifying spray paint 4 is applied as a plurality of secondary shades 10 onto the secondary transparent card 8, and the repaintable surface 7 is overlaid with the primary transparent card 1 and the secondary transparency card after Step E. The plurality of secondary shades modifies the color and hue of the matching primary shade 9. This allows for a visual comparison of combination of colors with the primary transparent card 1 and the at least one secondary transparent card 8. Each secondary shade 10 is compared to the matching primary shade 9 in order to identify a color-optimizing secondary shade 10 from the plurality of secondary shades 10. The color-optimizing secondary shade 10 is appended in the final color composition during Step G, thereby generating a better match for the final color composition. Similarly, a coat of toner is then applied onto the secondary transparent card 8 after applying the plurality of secondary shades 10 onto the secondary transparent card 8, in order to more accurately compare the plurality of secondary shades 10 with the primary shade 9 and the current color 6 for the repaintable surface 7 of an automobile.

In order to preserve the repaintable surface 7, the final color composition may be viewed on an opaque metal card. The opaque metal card serves as a trial surface to apply the final color composition and allows the color composition to be viewed on the comparable surface with that of the repaintable surface 7 of the automobile. The opaque metal card is painted with the final color composition before Step H, reducing the number of layers of spray paint applied across the repaintable surface 7 of the automobile. The opaque metal card is placed adjacent the repaintable surface 7, and the final color composition is verified by comparing the opaque metal card to the repaintable surface 7 for a final comparison. Similarly, a coat of toner is applied onto the opaque metal card after repainting the opaque metal card with the final color composition in order to visually compare the finished appearance between the final color composition and the current color 6 for the repaintable surface 7 of the automobile.

Although the invention has been explained in relation to its preferred embodiment, it is to be understood that many other possible modifications and variations can be made without departing from the spirit and scope of the invention as hereinafter claimed.

What is claimed is:

1. A method of matching a paint color to an automotive surface, the method comprises the steps of:
(A) providing a primary transparent card and a plurality of spray paints, wherein each spray paint is associated to a paint color;
(B) providing a current color for a repaintable surface of an automobile;
(C) comparing the paint color of each spray paint to the current color in order to identify a similarly-colored spray paint from the plurality of spray paints;
(D) applying the similarly-colored spray paint as a plurality of primary shades onto the primary transparent card;
(E) overlaying the repaintable surface with the primary transparent card;
(F) comparing each primary shade with the current color in order to identify a matching primary shade from the plurality of primary shades;
(G) appending the matching primary shade into a final color composition; and,
(H) repainting the repaintable surface with the final color composition.

2. The method of matching a paint color to an automotive surface, the method as claimed in claim 1 comprises the step of:
applying a coat of toner onto the primary transparent card after step (D).

3. The method of matching a paint color to an automotive surface, the method as claimed in claim 1 comprises the steps of:
applying a first coat of the similarly-colored spray paint across a full length of a primary transparent card during step (D);
applying a second coat of the similarly-colored spray paint across two-thirds of the full length of the primary transparent card; and,
applying a third coat of the similarly-colored spray paint across one-third of the full length of the primary transparent card.

4. The method of matching a paint color to an automotive surface, the method as claimed in claim 1 comprises the steps of:
providing at least one secondary transparent card;
comparing the paint color of each spray paint to the current color in order to identify at least one color-modifying spray paint from the plurality of spray paints;
applying the color-modifying spray paint as a plurality of secondary shades onto the secondary transparent card;
overlaying the repaintable surface with the primary transparent card and the secondary transparency card after step (E);
comparing each secondary shade to the matching primary shade in order to identify a color-optimizing secondary shade from the plurality of secondary shades; and,
appending the color-optimizing secondary shade in the final color composition during step (G).

5. The method of matching a paint color to an automotive surface, the method as claimed in claim 4 comprises the step of:
applying a coat of toner onto the secondary transparent card after applying the plurality of secondary shades onto the secondary transparent card.

6. The method of matching a paint color to an automotive surface, the method as claimed in claim 1 comprises the steps of:
providing an opaque metal card;
painting the opaque metal card with the final color composition before step (H);
placing the opaque metal card adjacent the repaintable surface; and,
verifying the final color composition by comparing the opaque metal card to the repaintable surface.

7. The method of matching a paint color to an automotive surface, the method as claimed in claim 6 comprises the step of:
applying a coat of toner onto the opaque metal card after painting the opaque metal card with the final color composition.
